(19) United States
(12) Patent Application Publication
(10) Pub. No.: US 2022/0371552 A1
(43) Pub. Date: Nov. 24, 2022

(54) Method for Melting a Body by Means of an Ultrasonic Wave

(71) Applicants: UNIVERSITE DE LILLE, LILLE (FR); CENTRALE LILLE INSTITUT, VILLENEUVE D'ASCQ CEDEX (FR); UNIVERSITE POLYTECHNIQUE HAUTS-DE-FRANCE, VALENCIENNES (FR); CENTRE NATIONAL DE LA RECHERCHE SCIENTIFIQUE, PARIS (FR); YNCREA HAUTS DE FRANCE, LILLE (FR); VALEO SYSTEMES D'ESSUYAGE, LE MENSIL SAINT DENIS (FR)

(72) Inventors: Adrien PERET, ISSOIRE (FR); Frederic BRETAGNOL, ISSOIRE (FR); Michaël BAUDOIN, VILLENEUVE D'ASCQ CEDEX (FR); Ravinder CHUTANI, LILLE (FR)

(21) Appl. No.: 17/763,018

(22) PCT Filed: Sep. 24, 2020
(86) PCT No.: PCT/EP2020/076760

§ 371 Date: Mar. 23, 2022

(30) Foreign Application Priority Data
Sep. 25, 2019 (FR) 1910588

(51) Int. Cl. B60S 1/02; B06B 1/06; B08B 17/02; B08B 7/00; B08B 7/02; G10K 11/36

(52) U.S. Cl. CPC B60S 1/023; B06B 1/0644; B08B 17/02; B08B 7/0071; B08B 7/028; G10K 11/36

(57) ABSTRACT

Method comprising: supplying electricity to at least one wave transducer (25) for synthesising an ultrasonic surface wave propagating in a medium (10) to a body (15) arranged on one side of the medium, at least one portion of the electrical supply energy being converted into heat by the transducer, the electrical energy supplied to the transducer being sufficient for the heat and the energy of the ultrasonic surface wave to cause: —the body to melt when the body is in the solid state, and/or—the body to be maintained in the liquid state when the temperature of the medium is below the solidification temperature of the body.

The present invention relates to a method for melting a body disposed on a surface by means of an ultrasonic surface wave, and preferably for displacing the molten body on the surface.

In many fields, it is necessary to overcome effects linked to the buildup of a liquid on a surface, and to the solidification of this liquid when the temperature of the environment and/or the temperature of the surface is lower than the temperature of solidification of the liquid.

For example, in the motor vehicle field, in winter conditions, it is necessary to defrost the mirror of a rear-view mirror, a windshield or a rear window of a vehicle to ensure safe driving. One known defrosting technique consists in blowing hot air over the face of the windshield opposite that on which a layer of frost and/or of ice is deposited. However, the defrosting time required for such a technique is particularly high. To defrost a rear window, it is known practice to dispose therein, in mass or in volume, a metal filament following a trajectory formed by evenly spaced apart lines. The circulation of an electrical current in the filament generates a heating by Joule's effect, which results in a melting of the layer of frost and/or of ice in proximity to the filament in the form of a film of water, then in the evaporation of the film of water. However, such a filament limits the rear vision field accessible to the driver of the vehicle. Furthermore, the layer of frost and/or of ice generally includes particles which remain in contact with the support once the film of water has evaporated. It is then necessary to often proceed with the cleaning of the rear window, which proves tedious.

The formation of frost and/or of ice also disrupts the operation of sensors. Modern motor vehicles generally include one or more driver assistance systems which implement numerous sensors, for example optical sensors, such as a lidar to assess a distance between the vehicle and an object, or probes, for example a Pitot probe. In order for these sensors to be able to supply information in real time, and with an acquisition frequency of several hertz, the defrosting times must be short. Furthermore, incorporating means to dispel the liquid after defrosting proves difficult in practice given the constraint of compactness required to incorporate the sensors in a vehicle.

WO 2012/095643 A1 describes a method for cleaning a windshield by vaporizing precipitations as soon as they strike the windshield. WO 2012/095643 A1 describes how the windshield can be defrosted by means of ultrasonic wave energy.

WO 2017/097769 A1, JP H08-140898 A and GB 2,518,136 A describe methods for cleaning drops disposed on a support.

There is therefore a need for a new and easy implementation method, for preventing the formation of a solid body on the surface of a support or for discharging the solid body from said surface, the method being able to be applied to media of varying forms, sizes and constituent materials.

The invention proposes a method comprising the electrical powering of at least one wave transducer to synthesize an ultrasonic surface wave that is propagated in a support to a body disposed on a face of the support, at least a portion of the electrical power supply energy being converted into heat form by the transducer, the electrical energy powering the transducer being sufficient for the heat or the energy of the ultrasonic surface wave to induce

the melting of the body when the body is in the liquid state, and/or

the maintaining of the body in the liquid state when the temperature of the support is lower than the temperature of solidification of the body.

The invention also proposes a method comprising the electrical powering of at least one wave transducer to synthesize an ultrasonic surface wave that is propagated in a support to a body disposed on a face of the support, at least a portion of the electrical power supply energy being converted into heat form by the transducer, the electrical energy powering the transducer being sufficient for the heat and the energy of the ultrasonic surface wave to induce

the melting of the body when the body is in the liquid state, and/or

the maintaining of the body in the liquid state when the temperature of the support is lower than the temperature of solidification of the body.

As will clearly emerge hereinbelow, the method according to the invention is easily implemented. In particular, it implements a wave transducer, which can be disposed so as not to disrupt the operation of a device comprising the support, or a user who, for example, is required to regularly look through the support.

At least a portion of the electrical energy powering the transducer is converted into the energy of the ultrasonic surface wave. Preferably, more than 5% of the electrical energy powering the transducer is converted into the energy of the ultrasonic surface wave.

A portion of the electrical energy powering the transducer is converted into heat form by the transducer. It is transferred to the body, by conduction in the support and/or by radiation.

Preferably, the transducer comprises electrodes that are electrically powered and in contact with a piezoelectric material. Upon the conversion of the electrical energy by the transducer, the heat can result from the heating of the electrodes by Joule's effect and/or from the heating by deformation of the piezoelectric material during the passage of an electric current in the electrodes and/or from the dissipation of the support by mechanical vibration.

The heat can represent more than 2%, even more than 5%, even more than 10%, even more than 30%, even more than 40% of the electrical energy powering the transducer. The share of the electrical energy converted into heat can depend notably on the fundamental frequency of the ultrasonic wave, on the width and on the thickness of the electrodes, on the nature of the metals used to constitute the electrodes, on the piezoelectric material or on the support. For example, the person skilled in the art knows how to reduce the share of the electrical energy converted into heat by Joule's effect by increasing the cross-section of the electrodes and by choosing a metal constituting the electrode that is of high electrical conductivity. Moreover, the person skilled in the art knows how to determine the width of the electrodes in order to define the fundamental frequency of the ultrasonic wave. He or she notably knows that the width of the electrodes, and therefore the section thereof, decreases with the frequency, notably when the electrodes form interdigital combs. Moreover, the person skilled in the art knows also that the dissipation of the support by mechanical vibration generally increases with the fundamental frequency of the ultrasonic wave.

The sum of the heat power and of the power of the ultrasonic wave, generated by conversion of the electrical power supply power by the transducer preferably lies between 1 milliwatt and 500 watts. The person skilled in the art knows easily how to adapt optimal electrical power supply power according to the distance at which the body is situated with respect to the transducer.

Preferably, the sum of the energy transferred to the ultrasonic surface wave and of the energy dissipated in heat form represents more than 90%, even substantially 100%, of the energy produced by the transducer.

The transducer can define a resistive heating member, the method comprising the heating of the body by means of the transducer. Advantageously, the melting of the body or the maintaining of the body in the liquid state is facilitated.

Preferably, the energy of the ultrasonic surface wave is also sufficient to induce the displacement of the body in the liquid state on the face of the support. Advantageously, the method can thus be implemented to clean the support of the body which coats it. The power of the ultrasonic surface wave can lie between 1 milliwatt and 500 watts. The displacement of the body in the liquid state can take place according to one or more axes contained in the face of the support.

Preferably, the energy of the surface wave is also sufficient to induce the displacement of the body in the liquid state on the face of the support in the direction of propagation of the surface wave in the absence of external force. In particular, the displacement of the body can take place in a variant in which an external force applied to the body is oriented in a direction that is substantially contrary, notably opposite or at right angles, to the direction of propagation of the surface wave. The term “external force” is understood to mean any force other than the acoustic force induced by the ultrasonic surface wave. The weight of the body or an aerodynamic force induced by the flow of a liquid on the body are examples of external force.

The displacement of the body in the liquid state can notably result from nonlinear acoustic effects of acoustic streaming and/or of radiation pressure induced by the ultrasonic surface wave.

In order to ensure an optimal melting of the body or a maintaining of the body in the liquid state, the fundamental frequency of the ultrasonic surface wave preferably lies between 0.1 MHz and 1000 MHz, preferably between 10 MHz and 100 MHz, for example equal to 40 MHz.

The amplitude of the ultrasonic surface wave can lie between 1 picometer and 500 nanometers. It can depend notably on the fundamental frequency of the acoustic wave. It corresponds to the normal displacement of the face of the support on which the ultrasonic surface wave is propagated and can be measured by laser interferometry.

The ultrasonic surface wave can be a Rayleigh wave or a Lamb wave. In particular, it can be a Rayleigh wave when the support has a thickness greater than the wavelength of the ultrasonic surface wave. A Rayleigh wave is preferred because a maximum proportion of the energy of the wave is concentrated on the face of the support on which it is propagated, and can be transmitted to the body.

The body can comprise a part in the solid state and a part in the liquid state. For example, the body can be water and be formed by a frosted, iced or snowy portion and a liquid portion in contact with the frosted, iced or snowy portion respectively.

The body in the liquid state can take the form of at least one drop or of at least one film. “Film” is understood to mean a thin film formed on the support. The film can be continuous or discontinuous.

The body can be aqueous. In particular, it can be rainwater or dew water. The rainwater and/or the dew water can notably contain particles. A dew water forms a mud on the surface of a support. It results from the condensation on the support, in ad hoc pressure and temperature conditions, of the water in vapor form contained in the air. The body can have been deposited by condensation before solidifying on the support.

The body in the solid state can be chosen from among a frost, ice and snow. The body in the liquid state can be a mud. A “frost” is formed by drops of water that have solidified before having been deposited on the support. “Ice” is formed by drops of water that have condensed on the support then solidified on the support.

The body can be at a distance from the transducer.

The support can be made of any material capable of propagating an ultrasonic surface wave. Preferably, it is made of a material having a modulus of elasticity greater than 0.1 MPa, for example greater than 10 MPa, even greater than 100 MPa, even greater than 1000 MPa, even greater than 10 000 MPa. A material having such a modulus of elasticity has a rigidity that is particularly suited to the propagation of ultrasonic surface waves.

The support can be self-supporting, inasmuch as it can be deformed, notably elastically, without breaking under its own weight.

The face of the support on which the longitudinal surface wave is propagated can be flat. It can also be curved, provided that the radius of curvature of the face is greater than the wavelength of the ultrasonic surface wave.

The face can be rough. The roughnesses will preferably be less than the fundamental wavelength of the ultrasonic surface wave, in order to prevent them from significantly affecting the propagation thereof.

The support can notably take the form of a flat plate, or a plate with at least one curvature in one direction. The thickness of the plate can be less than 0.1 m, even less than 0.01 m. The length of the plate can be greater than 1 mm, even greater than 1 cm, even greater than 1 m.

“Thickness of the support” is understood by considering the smallest dimension of the support measured in a direction at right angles to the surface on which the ultrasonic wave is propagated.

The support can be disposed flat with respect to the horizontal. As a variant, it can be inclined with respect to the horizontal by an angle α greater than 10°, even greater than 20°, even greater than 45°, even greater than 70°. It can be disposed vertically.

The support can be optically transparent, notably to light in the visible or to a radiation in the ultraviolet or in the infrared. The method is thus then particularly suited to the applications in which improving the visual comfort of a user observing his or her environment through the support is sought.

The support can be made of a material chosen from piezoelectric materials, polymers, in particular thermoplastics, notably polycarbonate, glasses, metals and ceramics.

Preferably, the support is made of a material other than a piezoelectric material.

Preferably, the support is chosen from the group formed by:

a motor vehicle surface, for example chosen from among a windshield of a vehicle, a glass of a rear-view mirror, or

a visor of a head set,

a window of a building,

a sensor, for example an optical sensor, a thermal sensor, an acoustic sensor or a pressure or speed sensor, notably a probe, for example a Pitot probe,

a surface of an optical device, the optical device being for example chosen from among a lens of a camera, an eyewear lens, and

a protection element of such a sensor.

Other types of support can be envisaged. Notably, the support can be a substrate of a laboratory-on-a-chip, notably intended for microfluidic applications. The support can be an electric cable. For example, in the variant in which the support is an electric cable of a high voltage electrical line and/or a railway power supply line, the method reduces the risk of damage to or even breakage of the cable under the effect of the weight of the ice accumulated on the cable.

The support can be an element of the structure of an aircraft, for example a wing, a fuselage or a tail unit.

The support can also be chosen from among an element of a heat exchanger, a plumbing installation and an element of a ventilation system. Such media generally have surfaces that are difficult to access to dispel the drops of liquid which are deposited thereon, for example by condensation, and which can solidify. The method according to the invention is therefore particularly suited to this type of support.

The support can be a food storage element, for example an internal wall of a refrigerator, or a wall exposed to the condensation of a liquid that can solidify. For example, in a refrigerator, the condensation of the drops of water and the solidification thereof on a wall increases the heat exchange between the wall and the cool air volume of the refrigerator, reducing its efficiency.

As has already been illustrated previously, the method according to the invention can be implemented in applications in which low temperatures are encountered. The temperature of the support can be lower than 0° C., even than −10° C. and, preferably, the body is aqueous.

The transducer can be fixed onto the support. In particular, it can be disposed on an edge of the support.

The transducer can at least partially cover the support, in particular the face of the support on which the body is disposed. The ratio of the area of the support covered by the transducer to the area of the face of the support on which the body is disposed can be less than 15%.

The body can be in contact with the face of the support on which the transducer is fixed, or on the face opposite the face of the support on which the transducer is fixed. The body can be in contact with the face of the support on which the transducer is fixed and another body can be in contact with the face on which the body is disposed.

The transducer can directly generate the ultrasonic surface wave. As a variant, it can generate an ultrasonic guided wave, which is propagated at the interface between the support and the transducer, then is transformed into the ultrasonic surface wave along a portion of the support disposed at a distance from the transducer.

The transducer can be in direct contact with the support or with an intermediate layer, for example formed by glue, disposed on the support.

Preferably, the transducer comprises first and second electrodes respectively forming first and second combs, the first and second combs being interdigital and being disposed on the support and/or disposed in direct contact with the support and/or in contact with an intermediate substrate in contact with, notably disposed on, the support, the substrate being made of a piezoelectric material.

The piezoelectric material can be chosen from the group formed by lithium niobite, aluminum nitride, lead zirconate titanate, zinc oxide, and the mixtures thereof. The piezoelectric material can be opaque to light in the visible.

In a variant, the support is formed by the piezoelectric material and the transducer comprises the support. The first and second combs are preferably disposed in contact with the support.

In another variant, the support is made of a material other than a piezoelectric material and the electrodes are disposed on the intermediate substrate.

The first and second electrodes can be deposited by photolithography on the support and/or on the substrate.

The first and second electrodes can be sandwiched between the support and the substrate, which preferably has a thickness greater, even at least two times greater, than the fundamental wavelength of the ultrasonic guided wave. As a variant, the substrate can be sandwiched between the support and the first and second electrodes, and preferably has a thickness less than the fundamental wavelength of the ultrasonic guided wave.

Moreover, the method can comprise the protection of the piezoelectric substrate by means of a protection member. In particular, the transducer can be housed in a chamber defined by the protection member and the support. At least one, even all, of the faces of the substrate without the first and second electrodes can be in contact with the protection member.

The first and second combs can preferably comprise a base from which a row of fingers extends, the fingers being preferably parallel to one another. The fingers can have a width lying between the fundamental wavelength of the ultrasonic wave divided by 8 and the fundamental wavelength of the ultrasonic wave divided by 2. The width of the fingers partly determines the fundamental frequency of the ultrasonic surface wave. Moreover, a small finger width increases the electrical resistance of the transducer, which can be reflected by a heating which can contribute to the melting of the body or to the maintaining of the body in the liquid state.

Moreover, the spacing between two successively adjacent fingers of a row of the first comb, respectively of the second comb, can lie between the fundamental wavelength of the ultrasonic wave divided by 8 and the fundamental wavelength of the ultrasonic wave divided by 2.

The number of interdigital fingers can be increased to increase the quality factor of the transducer.

The substrate can be a thin layer deposited, for example by chemical vapor deposition or by physical vapor deposition, on the support. As a variant, the substrate can be self-supporting, that is to say rigid enough not to bend under the effect of its own weight. The self-supporting substrate can be fixed, for example glued, onto the support.

The body is at a distance from the transducer. The portion of the body furthest away from the transducer can be at a maximum distance of 1 meter.

Moreover, the method preferably comprises the electrical powering of the transducer.

The electrical power supply of the transducer can be provided by means of an electric generator linked electrically to the conductor and delivering a power lying between 200 milliwatts and 500 watts.

In a preferred implementation, the method is implemented to clear and/or defrost the support chosen from the group formed by a motor vehicle surface, a visor of a head set, a surface of an optical device, and a protection element of such an optical device.

### BRIEF DESCRIPTION OF THE DRAWINGS

The invention will be able to be better understood on reading the following detailed description, of nonlimiting exemplary implementations thereof, and on studying the attached drawing, in which:

FIG. 1 schematically represents, by a perspective view, a device for implementing the method according to a first mode of implementation,

FIG. 2 is a cross-section of the device illustrated in FIG. 1,

FIG. 3 schematically represents a device for implementing the method according to the invention according to a second mode of implementation,

FIG. 4 represents, schematically and by a cross-sectional view, a device for implementing the method according to the invention according to a third mode of implementation,

FIG. 5 represents, schematically, by a cross-section, a device for implementing the method according to the invention according to a fourth mode of implementation,

FIGS. 6 a) to c) are photographs illustrating the defrosting of a glass support covered by a frost, by means of the method according to the invention, and

FIGS. 7 a) to c) are photographs illustrating the defrosting of a glass support covered with ice, by means of the method according to the invention.

The constituent elements of the drawing are not represented to scale in the interests of clarity.

### DETAILED DESCRIPTION

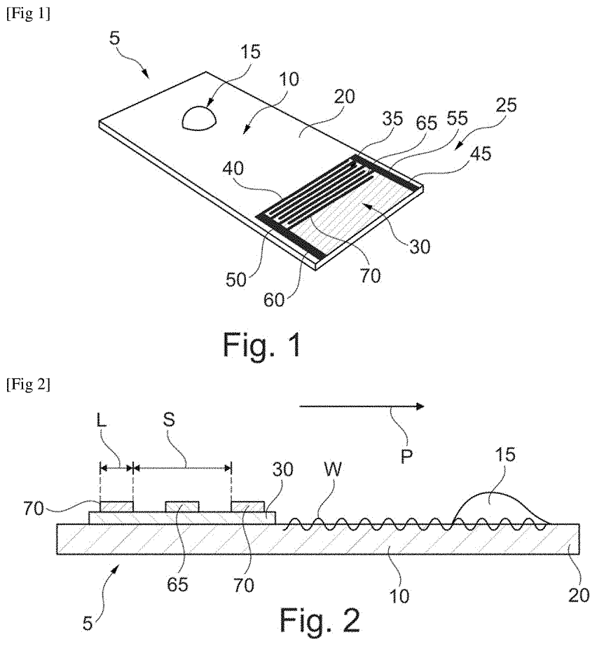

FIGS. 1 and 2 illustrate a device 5 for implementing the method according to the invention.

The device comprises a support 10 capable of propagating an ultrasonic surface wave, a body 15 disposed on a face 20 of the support and a wave transducer 25 for generating the surface wave, disposed on the face of the support on which the body rests.

The support is, for example, transparent to visible light. It can be made of glass.

The transducer comprises a substrate 30 on which the first 35 and second 40 electrodes are disposed. The substrate is, for example, made of 128° Y cut lithium niobate.

The substrate is formed by a thin layer deposited on the support, the thickness of which is less than the fundamental wavelength of the wave generated by the transducer. Thus, the wave generated by the transducer is transmitted directly in the support.

The electrodes are formed by an evaporation or sputtering method and formed by photolithography. They can be made of chromium, or aluminum or of a combination of an adhesion layer such as titanium and a conductive layer such as gold.

The first and second electrodes form first 45 and second 50 combs. Each comb comprises a base 55, 60 and a row of fingers 65, 70, extending parallel to one another from the base. The first and second combs are interdigital.

Each of the fingers of the first comb, respectively of the second comb, has a width 1 equal to the fundamental wavelength of the ultrasonic surface wave divided by 4 and the spacing S between two consecutive fingers of a comb is equal to the fundamental wavelength of the ultrasonic surface wave divided by 4.

The spacing between the fingers determines the resonance frequency of the transducer that the person skilled in the art can easily determine. An alternating voltage is applied by a generator 80 and can be amplified, such that the transducer generates an ultrasonic surface wave.

The alternating electrical powering of the first and second electrodes induces a mechanical response from the piezoelectric material, which results in the generation of an ultrasonic surface wave W which is propagated in the support according to a direction of propagation P, notably toward the body disposed on the support.

For a transducer configured to generate a wave of predetermined fundamental frequency, the determination of the energy generated by the transducer that is sufficient to melt the body and/or maintain it in the liquid state is easy for the person skilled in the art. Notably, the person skilled in the art knows how to link the fundamental frequency of the ultrasonic surface wave to the frequency of the electrical signal to generate the wave. He or she then knows how to vary the amplitude of the electrical signal so as to determine the adequate electrical energy to be supplied to the transducer.

The method according to the invention implements several physical phenomena which induce the melting of the body or the maintaining of the body in the liquid state when the temperature of the support is lower than the temperature of solidification of the body. The ultrasonic wave which is propagated in the support is absorbed and dissipated by the body, which is accompanied by an increase in the temperature of the body by dissipation of a portion of the energy of the ultrasonic wave transmitted to the body. Furthermore, the wave transducer can heat up by Joule's effect under the effect of the passage of the electrical current to generate the ultrasonic wave, and contributes to the increase in temperature of the body. Finally, the ultrasonic surface wave can displace the body in the liquid state, notably in the direction of propagation of the wave. Thus, the body in the liquid state can enter into contact with another portion of the body which is in the solid state and contribute to the heating up, even drive the melting, of this other portion.

The body can be in the solid state or in the liquid state. In particular, a part of the body can be in the solid state and a part of the body can be in the liquid state. For example, when the body is rainwater and the temperature of the support is lower than the temperature of solidification of the water, the drops of rain that have reached the support can be in the solid state or in the liquid state, depending on the time that has elapsed since they came into contact with the support.

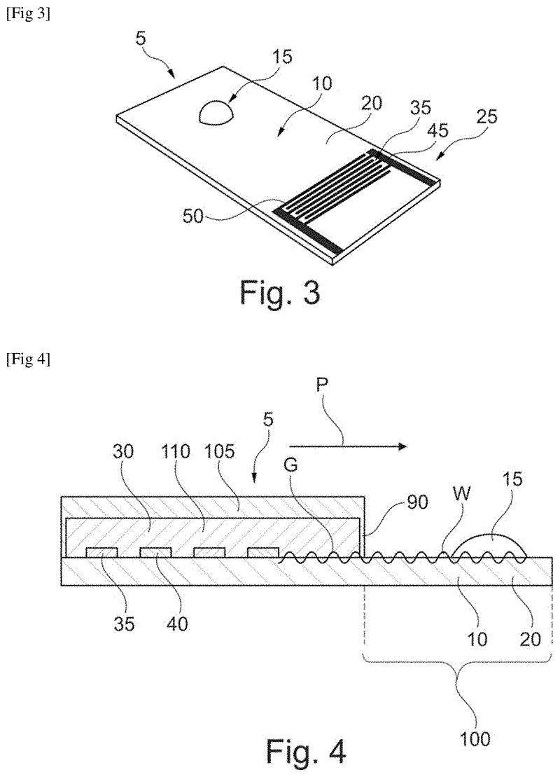

The device 5 of FIG. 3 differs from that of FIG. 1 in that the support 10 is a piezoelectric material and in that the device does not include an intermediate substrate. The first 45 and second 50 combs are directly in contact with the support.

The device of FIG. 4 differs from the device of FIG. 1 by several aspects. The transducer comprises a substrate 30 and the first 35 and second 40 electrodes are sandwiched between the support 10 and the substrate 30. Moreover, the transducer is glued onto the substrate. When an electric current passes through the first and second electrodes, the transducer generates an ultrasonic guided wave G, which is propagated between the support and the substrate. When the guided wave reaches the end 90 of the substrate along its direction of propagation, it is transformed into an ultrasonic surface wave W which is propagated in the portion 100 of the support separated from the substrate, substantially according to the same direction of propagation P as the guided wave. The transformation of the guided wave into surface wave results from the absence of interface between two solids in the portion 100 of the support.

The mode of implementation of the method by means of the device illustrated in FIG. 4 offers the advantage of protecting the first and second electrodes. For example, the body, when it is in the liquid state, cannot flow over the electrodes and oxidize them. Moreover, optionally, the device illustrated in FIG. 4 can comprise a protection member 105 which defines, with the support, a housing 110 for the transducer. For example, when the device 5 is mobile, damage to the transducer by objects striking the device is avoided.

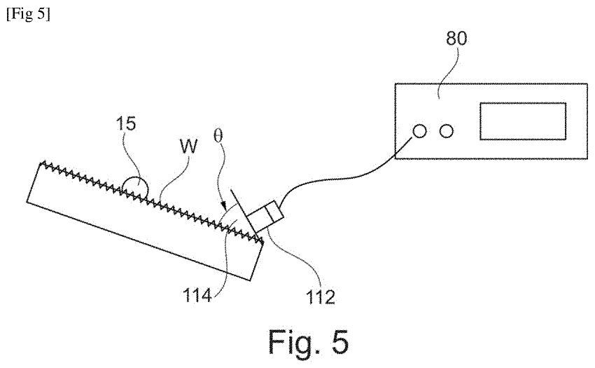

The transducer illustrated in FIG. 5 comprises a support made of non-piezoelectric material and a contact ultrasonic transducer 112 disposed in contact with the support. To optimize the propagation of the wave from the transducer to the support, a coupling material, for example a gel or a glue, can be disposed between the acoustic transducer and the support. In a first variant that is not illustrated, notably when the support has a thickness less than the ultrasonic surface wavelength and/or the latter is a Lamb wave, the contact ultrasonic transducer is preferably disposed at right angles with the surface on which the ultrasonic wave is propagated. A second transducer of the same type can be disposed on the face of the support opposite that on which the ultrasonic wave is propagated. In a second variant, as is illustrated in FIG. 5, notably when the support has a thickness greater than the ultrasonic surface wavelength and/or the latter is a Rayleigh wave, the contact ultrasonic transducer is disposed, for example by means of a boot 114, such that the axis of the transducer forms an angle θ with the normal to the surface on which the ultrasonic surface wave is propagated, less than 90° and the value of which can be determined by using the Snell-Descartes law.

### Example 1

To prepare the implementation of the method according to the example 1, a piezoelectric support 115 having a thickness of 1 mm and a diameter of 76 mm were made available.

Two interdigital electrodes as illustrated in FIG. 1 were deposited by evaporation and formed by photolithography on the support to form a transducer 25. The electrodes have comb forms as illustrated in FIG. 1. They each comprise 20 fingers having a length of 7.9 mm and a width of 25 μm and spaced apart from one another by 25 μm. The electrodes are linked to an IFR2023A generator and an Empower brand amplifier, model BBM0D3FE, to generate a Rayleigh wave propagated in the support. The energy of the ultrasonic surface wave generated is calculated on the basis of the measurement of the normal displacement of the surface by laser interferometry and the frequency of the wave.

A layer of frost 120 is formed on the surface of the support disk and is cooled in a refrigerating truck maintained at a temperature of −20° C. via the vaporization of liquid water at a temperature of 3° C. in the truck.

An electric current with a frequency of 38.4 MHz is generated and passes through the electrodes, such that the transducer generates an ultrasonic surface wave.

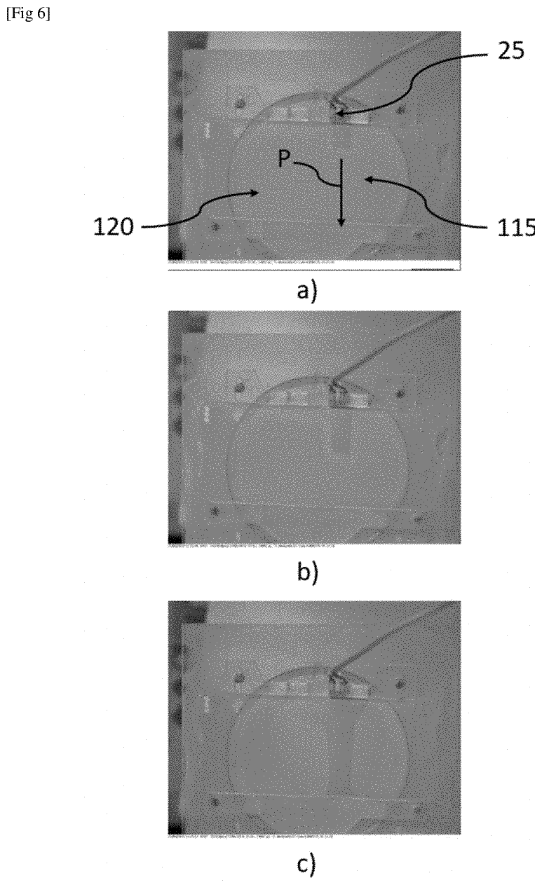

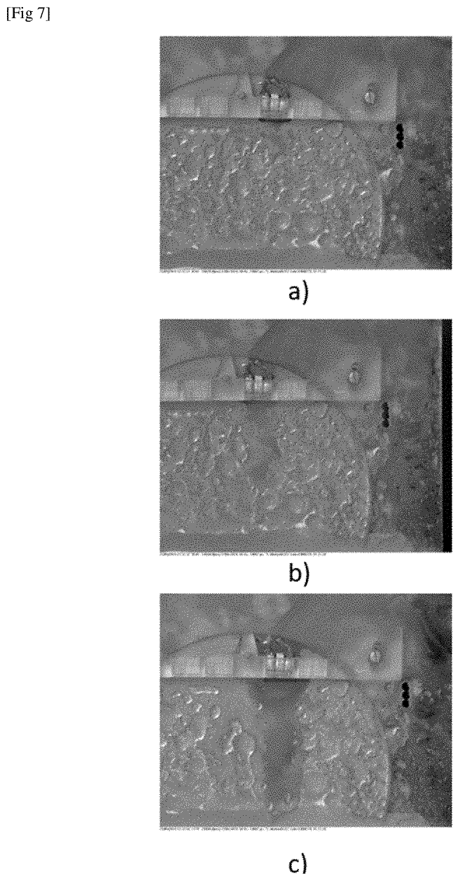

FIGS. 6a) to 6c) illustrate the progress of the defrosting 1, 3 and 14 seconds respectively after the application of an electric current to the terminals of the transducer.

As can be seen in FIG. 6a), in the first instants, the melting of the frost with the transducer is observed, and primarily in the direction of propagation P of the wave which is vertical in the image. Subsequently, as observed in FIGS. 6b) and 6c), the defrosting is facilitated by the displacement of the drops of liquid resulting from the melting of the frost in the direction of propagation of the wave. The drops come into contact with the frost and transmit, by conduction, the heat that they have accumulated by dissipation of the energy of the ultrasonic surface wave. Furthermore, the defrosting takes place in the direction of propagation of the wave and according to a transverse direction.

### Example 2

To prepare the implementation of the method according to the example 2, the method was as for the test 1, except that the support disk was previously covered with a film of ice.

FIGS. 7a) to 7c) illustrate the progress of the melting of the ice 1, 6 and 30 seconds respectively after the application of an electric current to the terminals of the transducer. Substantially the same effects are observed as for the example 1.

Obviously, the invention is not limited to the modes of implementation of the method, and notably to the examples, presented in the present description.

1.-16. (canceled)

17. A method of heating a body disposed on a support using a wave transducer, the method comprising:
providing electrical power to the wave transducer to generate ultrasonic surface waves that propagate through the support; and
heating the body using the ultrasonic surface waves, such that the body is converted from a solid state to a liquid state, and/or such that the body is maintained in the liquid state when the support is at a first temperature that is lower than a melting temperature of the body.

18. The method as claimed in claim 17, wherein when in the liquid state, the body comprises a droplet or a film.

19. The method of claim 17, further comprising displacing the body in the liquid state on the support using the ultrasonic surface waves.

20. The method of claim 17, wherein the body is aqueous.

21. The method of claim 17, wherein:
in the solid state, the body comprises frost, ice, and/or snow; and
in the liquid state, the body comprises liquid water and/or mud.

22. The method of claim 17, wherein the first temperature is a temperature of 0° C. of less.

23. The method of claim 17, wherein a fundamental frequency of the ultrasonic waves is between 0.1 MHz and 1000 MHz.

24. The method of claim 17, wherein a fundamental frequency of the ultrasonic waves is between 10 MHz and 100 MHz.

25. The method of claim 17, wherein the support is transparent or translucent.

26. The method of claim 17, wherein the support comprises a material chosen from piezoelectric materials, polymers, glasses, metals, or ceramics.

27. The method of claim 17, wherein the support comprises:
a motor vehicle surface;
a visor of a headset;
a window of a building;
a sensor;
a lens of an optical device; or
a protection element of an optical device.

28. The method of claim 17, wherein the transducer directly contacts the support or is connected to the support by an intermediate layer.

29. The method of claim 17, wherein the transducer comprises interdigitated electrodes disposed on the support.

30. The method of claim 29, wherein the transducer comprises a piezoelectric material disposed between the electrodes and the support.

31. The method of claim 30, wherein the piezoelectric material comprises lithium niobite, aluminum nitride, lead zirconate titanate, zinc oxide, a combination thereof.

32. The method of claim 17, wherein the providing electrical power to the wave transducer further comprises using the transducer to resistively heat the support and/or the body.

33. The method of claim 17, wherein the providing electrical power to the wave transducer further comprises:
generating an ultrasonic guided wave that is propagated between the support and the transducer; and
transforming the ultrasonic guided wave into a surface ultrasonic wave in a zone of the support disposed at a distance from the transducer.

34. A method of clearing a support using a wave transducer disposed on the support, the method comprising:
providing electrical power to the wave transducer to generate ultrasonic waves that propagate through the support and to resistively heat the support;
heating ice disposed on the support using the ultrasonic waves, such that the ice is converted into water droplets; and
displacing the water droplets from the support using the ultrasonic waves.

35. The method of claim 35, wherein:
the wave transducer comprises interdigitated electrodes disposed directly on the support;
the support comprises a piezoelectric material;
the providing electrical power to the wave transducer comprises providing power to the interdigitated electrodes, such that the piezoelectric material generates the ultrasonic waves; and
the ultrasonic waves comprise Rayleigh waves.

36. The method of claim 35, wherein:
the wave transducer comprises interdigitated electrodes disposed on a piezoelectric layer;
the providing electrical power to the wave transducer comprises providing power to the interdigitated electrodes, such that the piezoelectric layer generates the ultrasonic waves; and
the ultrasonic waves comprise Rayleigh waves.
